(19) United States
(12) Patent Application Publication
(10) Pub. No.: US 2015/0216143 A1
(43) Pub. Date: Aug. 6, 2015

(54) ADVANCED PET EXCREMENT CAPTURING & DISPOSAL TOOL

(71) Applicant: Jeffrey Christlieb, Ft. Lauderdale, FL (US)

(72) Inventor: Jeffrey Christlieb, Ft. Lauderdale, FL (US)

(21) Appl. No.: 14/174,028

(22) Filed: Feb. 6, 2014

(51) Int. Cl. A01K 23/00

(52) U.S. Cl. CPC A01K 23/005

(57) ABSTRACT

A central extensible portion comprised of two tubes has a handle portion at one end. This handle portion has a battery loading zone with a velcro attachment strip. The other end of the far tube has a wishbone attachment having a wishbone holder. The wishbone is rotationally attached thereto upon an integral axle wheel. The wheel has two associated locking protrusions: one for ordinary use and one for storage.

### FIELD OF THE INVENTION

The present invention relates to a mechanism for assisting pets in their waste function. More particularly, this invention related to improvements designed to assist in capturing and packaging pet waste for proper disposal that is easy to use and sanitary.

### BACKGROUND OF THE INVENTION

In modern times pets such as dogs and cats have become members of many households that need to be fed, washed and groomed. Of particular concern is the control and disposal of their waste products in an efficient and sanitary manner. Typically, an owner follows a pet around with a rolled up plastic bag for collection of waste material. Once the dog or cat has had a bowel movement the owner scoops up the excrement using the plastic bag and seals it with a simple tying of the neck of the bag. While this is a simple system it requires an owner to bend down and pick up the material by hand; this is of course difficult for those that have back problems. Further, collecting the waste material by hand even when grasping it through the walls of the bag is an unpleasant experience that can have unsanitary transference of microbes from animal to human host.

Thus, there needs to be some solution to the aforementioned problems.

### SUMMARY OF THE INVENTION

A pet excrement capturing tool comprising:

an extensible tubular device;

a handle portion attached to the extensible tubular member; and

a wishbone holder attached to the extensible tubular device.

In another aspect,

a flashlight holder portion formed from the handle portion.

In another aspect,

a rotational axle integral with the wishbone holder thereby attached rotationally to the extensible tubular device.

In another aspect,

a storage locking device.

In another aspect,

a usage locking device.

In another aspect,

an integral intermediate cylinder integral with the rotational axle and the wishbone holder.

In another aspect,

an integral pair of wishbone legs extending outwards from the integral intermediate cylinder.

In another aspect,

a support protrusion located on the integral intermediate cylinder.

In another aspect,

an L shaped support protrusion located at the end of a wishbone leg.

In another aspect,

an L shaped support protrusion located at the end of each wishbone leg.

In another aspect,

a support protrusion located on the back of a wishbone leg.

In another aspect,

a support protrusion located on the back of each wishbone leg.

In another aspect,

a waist support member integral with the handle portion.

A holding device comprising:

a handle connected to

a telescoping tubular device having

a rotationally actuating capturing device attached thereto.

In another aspect,

a circular device integral with the rotationally actuating capturing device having a concentric axle thereon.

In another aspect,

a storage mode locking device integral with the circular device.

In another aspect,

a usage mode locking device integral with the circular device.

In another aspect,

a waist holding tongue parallel to the telescoping tubular device and integral with the handle.

In another aspect,

a flashlight holder device integral with the handle.

A pet disposal apparatus comprising:

a handle having a tube attached to a rotational waste disposal device.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 is a perspective view of an extended assembled advanced pet excrement capturing and disposal tool.

FIG. 2 is a perspective view of a a handle assembly, telescoping tube and wishbone holder assembly.

FIG. 3 is a closeup perspective view of a top portion of a handle assembly.

FIG. 4 is a closeup perspective view of a wishbone holder assembly.

FIG. 5 is a closeup perspective view of the wishbone.

FIG. 6 is a closeup view of the wishbone holder attached to the swivel wheel.

FIG. 7 is a side view of a bag loaded onto the wishbone holder.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

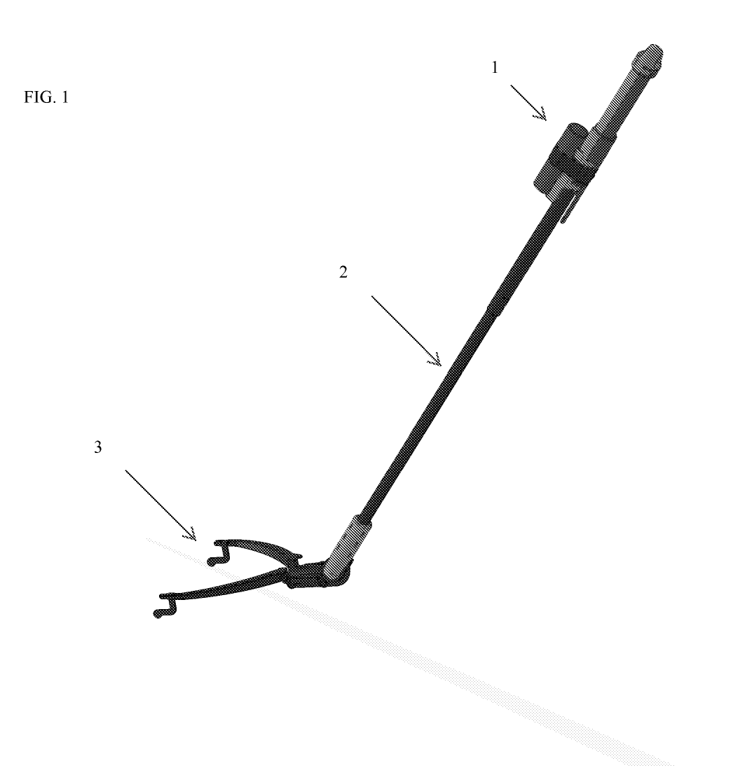

FIG. 1 is a perspective view of an extended assembled advanced pet excrement capturing and disposal tool. FIG. 1 shows the three main components making up the assembled advanced pet excrement capturing and disposal tool; these are namely, a handle assembly/tube 1, a telescoping tube/wishbone holder 2 and a bag wishbone 3 and associated holder; other components of the embodiment are also described as necessary. Each of these parts is made from a plastic type material having varying degrees of flexibility based upon the needs of the implementation and the functions thereof. The harder components such as the handle assembly 1 and telescoping tube 2 would use a PVC type plastic while the bag wishbone 3 would use an elastomer plastic material. The use of this type of plastic is not meant to limit the scope of the invention but is mentioned for purposes of illustration.

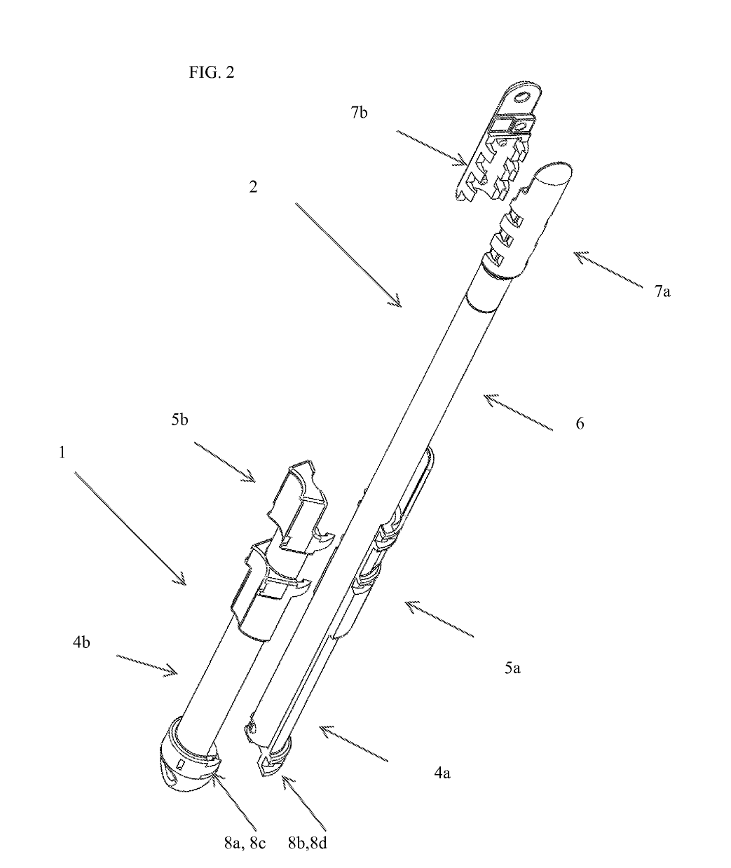

FIG. 2 is a perspective view of a handle assembly, telescoping tube and wishbone holder. A handle assembly, telescoping tube and wishbone holder comprises a primary base assembly that has two components attached thereto. The telescoping tube is made from two tubes 16, 17 where 16 is inserted in 17 or vice versa. It should be understood that the tube whether 16 or 17 inserted in the other one has a small circumferential lip that is used to prevent it from sliding out of the other tube once locked in place by a machine or man crimping (slight precise crushing of) the other external tube about its circumference; thus, the crimp blocks motion of the lip thereby locking the two tubes together.

The primary base assembly is made from an integral piece of plastic generally divided into portions referred to as a handle zone/tube portion and a tube/wishbone attachment zone. The handle zone/tube portion is made from a single piece of plastic further having a handle attachment 4b/5b connected to the half handle 4a and attachment portion 5a; as well as a half handle 4a integral with a an attachment portion 5a on into a long hollow tubular portion 6 that runs integral with and underneath the half handle 4a and attachment portion 5a.

The tube/wishbone attachment zone 7a is is made from a single piece of plastic and is comprised of a generally long tube that is inserted in the first hollow tub at one end and is integral with a wishbone attachment zone 7a at the other end. The first 4b/5b of the two attachment components otherwise known as the handle attachment is made from a single piece of plastic and is comprised of the other side 4b of the half handle 4a; this other side is integral with a flashlight loading zone 5b. The second 7b of the two attachment components is made from a single piece of plastic and is comprised of the other side of the wishbone attachment zone. Finally, it should be understood that a arrow headed protrusion 8a and matching cutout 8b on the end of the device work together at the base along with arrow cutout 8c and protrusion 8d to lock the end cap together. This will be described in more detail in the following discussion with reference to the accompanying drawings; 8a-8d are discussed with regards to the handle part of the device suffice it to say here that the end cap region works identically with two flanges 8f for making flush the surface on either side of the arrowhead 8a cutouts located adjacent to the arrowhead 8a.

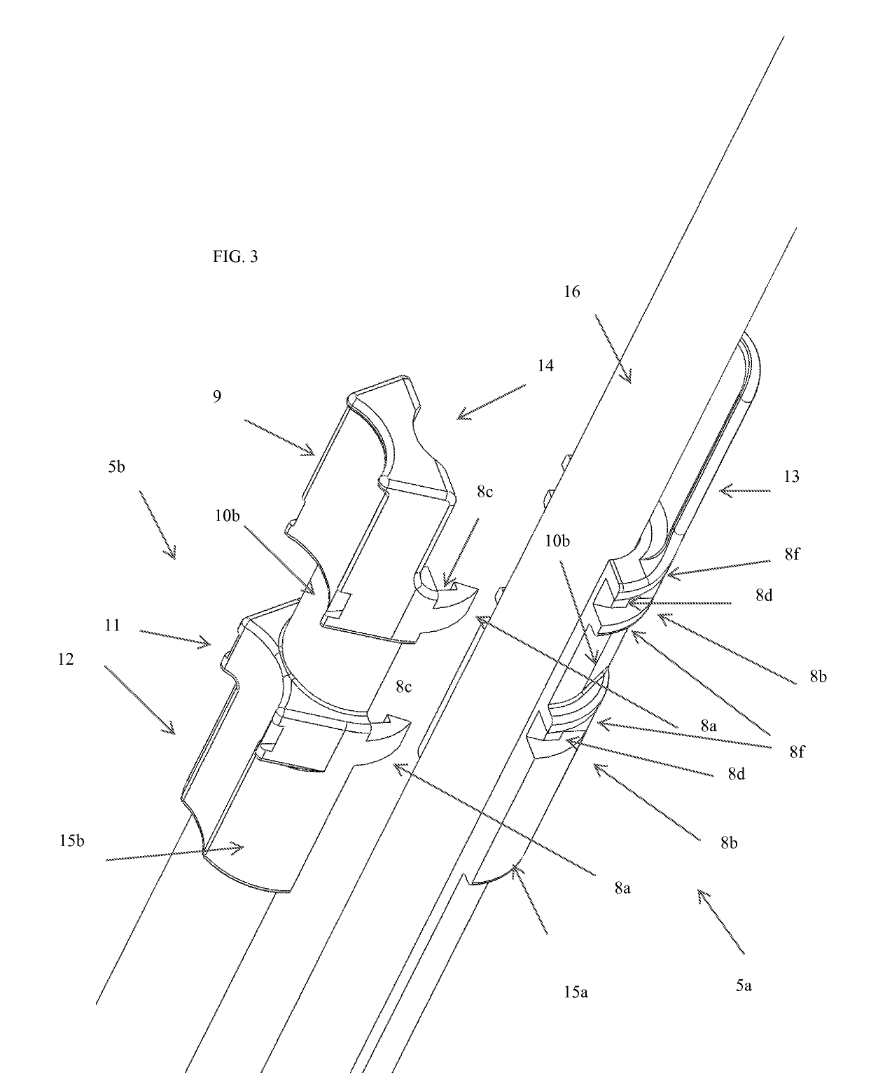

FIG. 3 is a closeup perspective view of a handle assembly more particularly referring to an attachment portion 5a and corresponding portion 5b known as the flashlight loading zone. A hollow tube 6 runs down the center of the handle zone/tube portion starting at an end cap attachment and proceeding for a short space forming a gripping portion and on into the the attachment portion 5a and beyond. Thus, the attachment portion 5a proceeds out of a single piece of plastic from the hollow tube described previously. The attachment portion 5a commences with a short section 15a larger in radius then the tube 6 and proceeds on into a cutout section 8b that has a corresponding portion 15b on the flashlight loading zone 5b.

This semi-circular cutout section 8b is a small circumferential region designed to be mated with a corresponding half arrow headed protrusion 8a from the flashlight loading zone 5b and attachment portion; this half arrow headed protrusion 8a has a lower cutout portion 8c thereby forming the triangular arrow head. To accomplish the attachment, a protrusion 8d closely matches the lower cutout portion 8c of the half arrow headed protrusion 8a found on the flashlight loading zone 5b and attachment portion. Thus, when the two sides are brought together the arrow head 8a engages the protrusion 8d. It should be understood that the outer surface of the arrow headed portion 8a is flush with the proximate surfaces as described more fully in the following.

At this point the attachment portion 5a has a circumferential flange 8f that proceeds for only a portion of the circumference of the tube 16; when the two parts 5a, 5b are brought together it sits flush with the inner sides of a bottom of the flashlight portion 11 by utilizing a side cutout next to the arrow headed protrusion 8a; this where the velcro attachment strap is to be adhesively connected. Then the attachment portion 5a proceeds onwards in a tubular section 10b that is of the same diameter as the main tube 16 that ends in a second flange 8f that sits similarly in a side cutout next to a second arrow headed protrusion 8a on 5b when the two parts 5a, 5b are brought together. Of course, to accomplish this requires a similar cutout arrangement as before.

That is, after the flange 8f there is a cutout section 8b. This cutout section 8b is a small portion semicircular circumferential region designed to be mated with a corresponding half arrow headed protrusion 8a from the flashlight loading zone 5b and attachment portion; this half arrow headed protrusion 8a has a cutout 8c thereby forming the triangular head. To accomplish the attachment, a protrusion 8d closely matches the lower cutout portion of the half arrow headed 8a protrusion found on the flashlight loading zone 5b and attachment portion. Thus, when the two sides are brought together the arrow head 8a engages the protrusion 8d.

A final flange 8f proceeds for only a portion of the circumference of the tube 16; when the two parts 5a, 5b are brought together it sits flush with the outer sides of a bottom of the flashlight portion 11 by utilizing a side cutout next to the arrow headed protrusion 8a; this where an overhang 9 of the front portion of the flashlight loading zone is. At this point the flange turns perpendicularly and proceeds longitudinally parallel down the tube 16 creating a tongue parallel thereto; thus, the attachment portion 5a has a generally rectangular tongue that juts out parallel to the tube 16.

A flashlight loading zone 5b has a top overhang 9 having a concave surface and a T shaped second concave surface made of two regions of the T 11 and 12. The forward portion 11 of the T shaped region is integrally followed by the rear longer portion of the T shaped region 12. Between the two is a connection round region 10b. It should be understood that the underside of all of these parts of 5b has a longitudinal concavity running underneath that matches the top surface of the tube 16; thus, when brought together the two mesh appropriately.

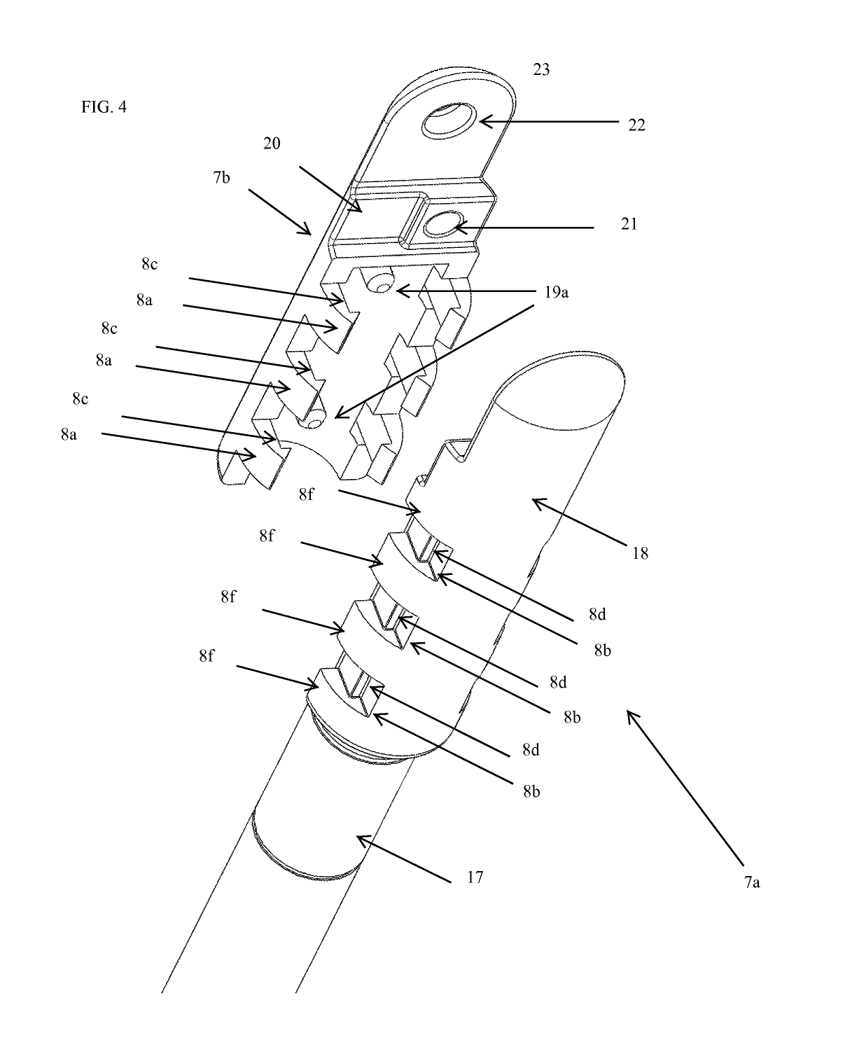

FIG. 4 is a closeup perspective view of a wishbone holder assembly. The tube/wishbone attachment zone 7a proceeds first from a hollow tube 17 that integrates with a wishbone attachment zone 7a. The zone 7a is generally circular in shape being formed from a semicircular part 18 having cutouts described below. There are three attachment point cutouts 8b along either of two sides that match a corresponding dual row of arrow headed protrusions 8a that are on attachment component 7b. These are similarly disposed as described previously with regards to FIG. 2.

The difference here being that there is are four ‘flanges’ or surfaces that are somewhat larger than previously described for FIG. 2; these help to buttress the arrowhead 8a to 8b connection using the protrusion 8d in the cutouts 8c that snap on thereto. It should be understood that when the two parts are brought together the curved outer surface of the arrowhead 8a lies flush with the outer surface of the semicircular part 18.

Next, there are two round protrusions 19a in the undersurface of attachment 7b that are arranged longitudinally between the arrow headed protrusions. These are designed to be inserted in corresponding holes 19b (not shown) in the undersurface of semicircular part 18 thereby adding extra stability. A shallow circular depression 22 is located at the end 23 of 18 for insertion of the axle of the wishbone holder as described below. This depression 22 has a corresponding depression on the attachment component 7b for the other side of the axle of the wishbone holder to be described below in more detail.

Finally, there are two locking depressions 21 (the one on 18 is not shown) one located directly underneath a square cutout section 20 of 7b (ordinary use) and one located on the part 18 but opposite the cutout portion 20 of 7b (folded). These depressions cooperate with protrusions from the wishbone member such that the first of these locking depressions holds the wishbone holder in place during ordinary use and the second holds it in place when the wishbone holder is folded.

Finally, the tubular portion 10b when brought together with 5a/5b forms a locking space for a strip of material having velcro attached thereto. The strip (not shown) is attached at one end thereof with adhesive and thereupon wrapped about the tubular portion 10b such that it wraps about a flashlight mounted on 9, 11, 12. Velcro hooks and loops attached to the strip are used to lock the flashlight in place where the hooks portion is on one side of the strip and the loops are on a corresponding opposite side of the strip when wrapped appropriately thereabouts.

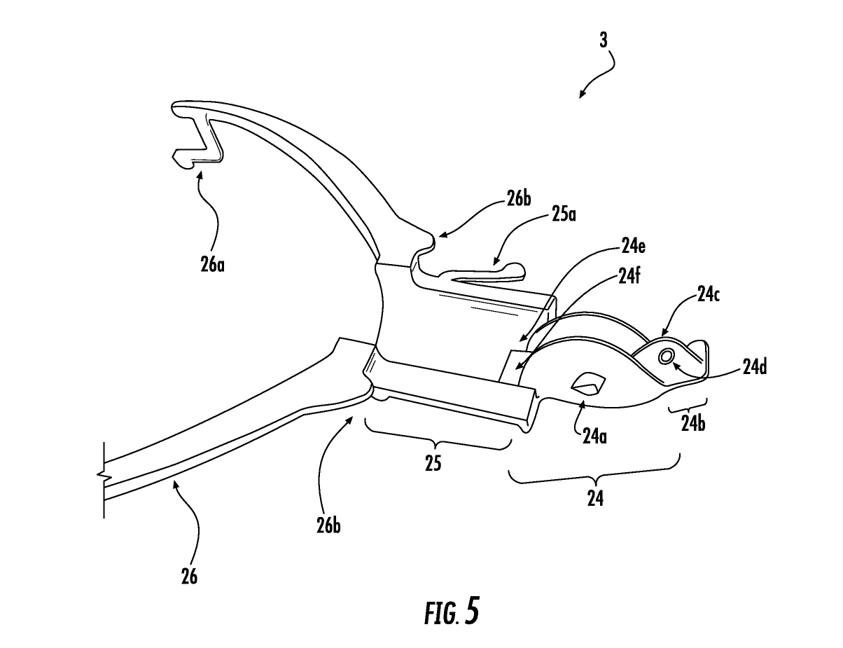

FIG. 5 is a closeup perspective view of the wishbone zone. The bag wishbone 3 is made up of various integral components made from plastic including but not limited to: a swivel wheel 24, a semicircular intermediate cylinder 25 and a wishbone holder 26. The swivel wheel 24 has a central axle 24 that extends outwards from either side. At the free end of the swivel wheel 24 is a flange extension 24b that juts out an angle from the horizontal plane of the entire bag wishbone 3.

This extension 24b is a flat member extending out tangentially to the wheel 24 and having a central perpendicularly disposed flat protrusion 24c; also, the extension 24b is made of two flanges that extend outwards on either side of flat protrusion 24c that ensure that the wishbone holder 3 does not proceed further than these stops when it is in operating mode. The surface of the flat protrusion 24c has a round protrusion (disposed outwards in the drawing) 24d that serves to lock the wishbone bag in place as it corresponds with the depression 21 on attachment component 7b. Two protrusions 26b extend outwards from the wishbone legs 26 facing the user such that they can be utilized as bag holders as well.

The swivel wheel blends into the intermediate cylinder 25 as one piece; further, there is a flat perpendicular protrusion 24e integral with the left side of the wheel 24 and running along the centerline of the intermediate cylinder 25 that serves a similar purpose as 24c. This flat protrusion 24e has a round protrusion (disposed inwards in the drawing, dotted) 24f that serves to lock the wishbone bag in place as it corresponds with the depression 21 on 18 that is not shown. This depression 21 located on 18 but opposite the cutout portion 20 of 7b (folded) cooperating with the round protrusion 24f holds it in place when the wishbone holder is folded back upon the tube 2, 6; it should be understood that between the inside of 18 and 23 there is sufficient space to permit the entry of the swivel wheel protrusions 24d, 24f that lock the wheel in place against depressions 21. Finally, a bag support 25a is a protrusion approximately parallel to the external surface of the intermediate cylinder 25; this is used to wrap bags that are larger than the ordinary bag thereabout.

At the end of the intermediate cylinder 25 two legs 26 of the wishbone open disposed as an approximate triangular or better rounded conical shape extending outwards. They end with two reverse L shaped protrusions 26a that extend downwards and then away from the wishbone 26; these L shaped protrusions 26a are used to catch or wrap the front portion of a bag thereabouts.

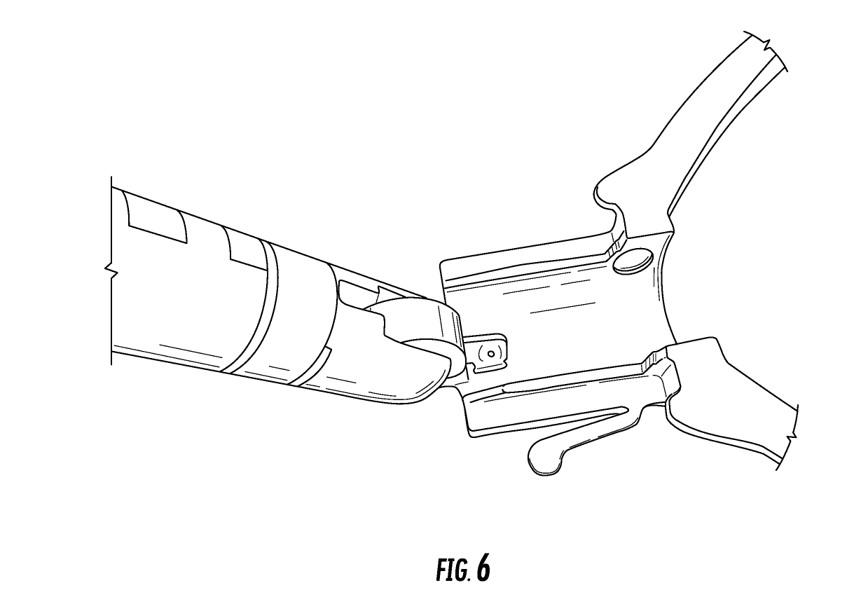

FIG. 6 is a closeup view of the wishbone holder attached to the swivel wheel.

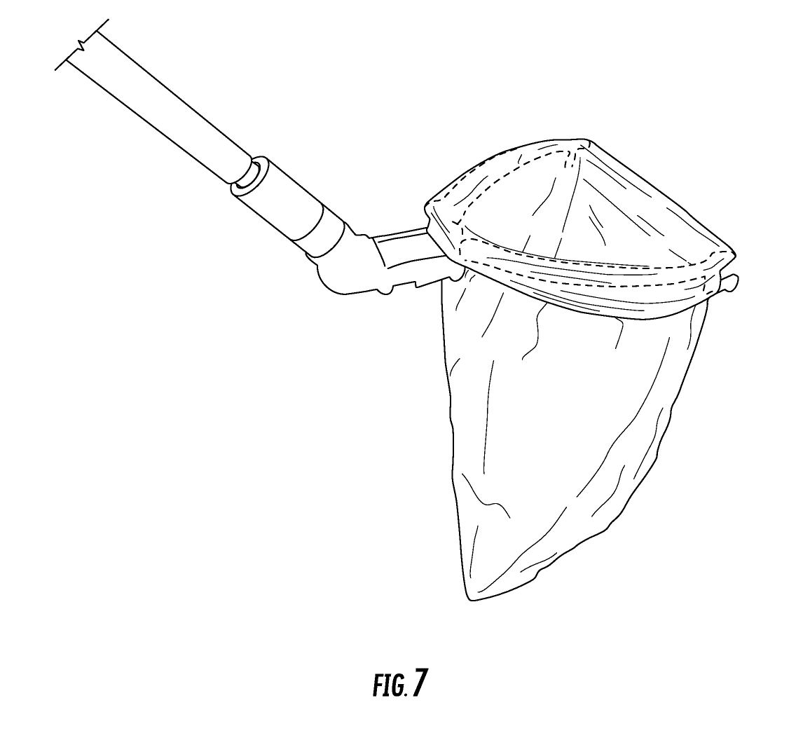

FIG. 7 is a side view of a bag loaded onto the wishbone holder.

Final Considerations:

Burrs can be added or deleted as needed; that is protrusions on the side of the cylinder can be added or needed for the implementations. Any of the parts disclosed herein are combinable in any combination so as to get various implementations of the collection tool. Finally, the device herein is made from plastic of PVC and elastomer varieties as required.

What is claimed is:

1. A pet excrement capturing tool comprising:
an extensible tubular device;
a handle portion attached to the extensible tubular member; and
a wishbone holder attached to the extensible tubular device.

2. The pet excrement capturing tool of claim 1, further comprising:
a flashlight holder portion formed from the handle portion.

3. The pet excrement capturing tool of claim 1, wherein the wishbone holder further comprises:
a rotational axle integral with the wishbone holder thereby attached rotationally to the extensible tubular device.

4. The pet excrement capturing tool of claim 1, wherein the wishbone holder further comprises:
a storage locking device.

5. The pet excrement capturing tool of claim 1, wherein the wishbone holder further comprises:
a usage locking device.

6. The pet excrement capturing tool of claim 1, further comprising:
an integral intermediate cylinder integral with the rotational axle and the wishbone holder.

7. The pet excrement capturing tool of claim 6, further comprising:
an integral pair of wishbone legs extending outwards from the integral intermediate cylinder.

8. The pet excrement capturing tool of claim 6, further comprising:
a support protrusion located on the integral intermediate cylinder.

9. The pet excrement capturing tool of claim 7, further comprising:
an L shaped support protrusion located at the end of a wishbone leg.

10. The pet excrement capturing tool of claim 7, further comprising:
an L shaped support protrusion located at the end of each wishbone leg.

11. The pet excrement capturing tool of claim 7, further comprising:
a support protrusion located on the back of a wishbone leg.

12. The pet excrement capturing tool of claim 7, further comprising:
a support protrusion located on the back of each wishbone leg.

13. The pet excrement capturing tool of claim 1, further comprising:
a waist support member integral with the handle portion.

14. A holding device comprising:
a handle connected to
a telescoping tubular device having
a rotationally actuating capturing device attached thereto.

15. The holding device of claim 14, further comprising:
a circular device integral with the rotationally actuating capturing device having a concentric axle thereon.

16. The holding device of claim 14, further comprising:
a storage mode locking device integral with the circular device.

17. The holding device of claim 14, further comprising:
a usage mode locking device integral with the circular device.

18. The holding device of claim 14, further comprising:
a waist holding tongue parallel to the telescoping tubular device and integral with the handle.

19. The holding device of claim 14, further comprising:
a flashlight holder device integral with the handle.

20. A pet disposal apparatus comprising:
a handle having a tube attached to a rotational waste disposal device.
